(19) United States
(12) Patent Application Publication
(10) Pub. No.: US 2024/0111997 A1
(43) Pub. Date: Apr. 4, 2024

(54) RECOGNITION OF USER-DEFINED PATTERNS AT EDGE DEVICES WITH A HYBRID REMOTE-LOCAL PROCESSING

(71) Applicant: AONDEVICES, INC., Irvine, CA (US)

(72) Inventors: Mouna Elkhatib, Irvine, CA (US); Adil Benyassine, Irvine, CA (US); Aruna Vittal, Irvine, CA (US); Eli Uc, Irvine, CA (US); Daniel Schoch, Irvine, CA (US); Ziad Mansour, Irvine, CA (US)

(21) Appl. No.: 18/477,763

(22) Filed: Sep. 29, 2023

Related U.S. Application Data
(60) Provisional application No. 63/411,424, filed on Sep. 29, 2022.

(51) Int. Cl. G06N 3/045; G06V 10/44

(52) U.S. Cl. CPC G06N 3/045; G06V 10/443

(57) ABSTRACT

A system for configuring user-defined recognition patterns at an edge device using a hybrid cloud-edge device approach has a pattern recognition integrated circuit implementing a machine learning pattern recognizer that generates an event recognition output in response to an input thereto based upon pre-trained machine learning weights stored in a memory of the pattern recognition integrated circuit. A remote pattern recognition training service is in communication with a secondary user device receptive to a training input of the user-defined recognition patterns, and returns a set of training weights corresponding to the training input. An application interface connects the pattern recognition integrated circuit to the secondary user device, with the set of training weights returned to the secondary user device being transferable to the machine learning pattern recognizer for storage in the memory of the pattern recognition integrated circuit.

### CROSS-REFERENCE TO RELATED APPLICATIONS

This application relates to and claims the benefit of U.S. Provisional Application No. 63/411,424 filed Sep. 29, 2022 and entitled “METHOD FOR RECOGNIZING USER-DEFINED PATTERNS AT THE EDGE DEVICES UTILIZING A HYBRID CLOUD-CHIP APPROACH,” the entire disclosure of which is wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to human-computer interfaces and machine learning, and more particularly to recognizing user-defined patterns at edge devices utilizing a hybrid remote-local processing approach.

### 2. Related Art

Virtual assistant systems are incorporated into a wide variety of consumer electronics devices, including smartphones/tablets, personal computers, wearable devices, smart speaker devices such as Amazon Echo, Apple HomePod, and Google Home, as well as household appliances and motor vehicle entertainment systems. In general, virtual assistants enable natural language interaction with computing devices regardless of the input modality, though most conventional implementations incorporate voice recognition and enable hands-free interaction with the device. Examples of possible functions that may be invoked via a virtual assistant include playing music, activating lights or other electrical devices, answering basic factual questions, and ordering products from an e-commerce site. Beyond virtual assistants incorporated into smartphones and smart speakers, there are a wide range of autonomous devices that capture various environmental inputs and responsively performing an action, and numerous household appliances such as refrigerators, washing machines, driers, ovens, timed cookers, thermostats/climate control devices, and the like now incorporate voice-controlled interfaces.

Because consistency in the user interaction experience across a product ecosystem is desirable, the same virtual assistant system may be deployed in different device categories. For instance, Apple mobile phones, tablets, watches, and computers may incorporate the Siri virtual assistant system, while mobile devices incorporating the Google Android operating system may incorporate the Google Assistant virtual assistant system. Amazon.com devices such as the Echo smart speaker and the Fire tablet may incorporate the Alexa virtual assistant system. Although the developers of these virtual assistant systems may not offer the full spectrum of Internet of Things (IoT) devices, third party manufacturers of such devices may license and incorporate one or more of these virtual assistants into their products. As an example, a third-party smart thermostat device may include the Amazon Alexa virtual assistant as well as the Apple Sin virtual assistant. Moreover, the virtual assistant systems typically include integrations that allow the user to interact with third party IoT devices through the mobile phone, smart speaker, or other interactive device with the virtual assistant native thereto.

With the varying data processing power available on different devices, the processing demands of the virtual assistant systems are minimized, particularly in relation to those components that are implemented on the local device. Smartphones, tablets, and other such general-purpose computing devices may be programmed with software modules that are persistently executing in the background to capture wake words such as “Hey Alexa” or “Siri” and the like and capture additional audio data of the query or command that is uttered by the user thereafter. On IoT edge devices with more limited processing capabilities, this initial voice activation/waking features may be implemented on a dedicated hardware integrated circuit.

Regardless of the specific situs of implementation, the voice activation/waking features may be a pattern recognizer that receives an incoming audio signal and determines whether the pattern represented by that signal corresponds to the wake word. In some cases, instead of an utterance of a wake word, the system may be invoked in response to the reception of other sounds such as glass breaking, a baby screaming, or the like. A recognition of the wake word may invoke the virtual assistant system to begin capturing additional audio data corresponding to a command or inquiry, and transmitting the recording to a remote service for recognition and other processing. This audio data is understood to be substantially more complex, so the remote service with greater processing capability to implement neural networks and other machine learning systems may be best suited for this recognition task. The response to the query or command may then be returned to the local device for output.

Existing systems are understood to implement only a fixed set of pattern recognition functions and is typically set by the original equipment manufacturer. Typically, this is the wake word specific to the virtual assistant platform. In some cases, additional sounds that may signal urgent situations such as breaking glass or the like may also be pre-programmed as a wake condition. The number of such wake sounds may be limited due to lower memory capacity and other hardware limitations. Existing systems are thus limited in that the user is unable to customize specific pattern recognition functions on the edge devices according to their needs.

Therefore, there is a need in the art for a pattern recognition system with user-definable patterns on edge devices utilizing a hybrid remote and local processing approach. There is also a need for such pattern detection integrated circuits to incorporate an embedded deep learning system, along with a user-facing application as well as a tool platform to train the deep learning system via a remote system.

### BRIEF SUMMARY

The present disclosure contemplates systems and methods for recognizing user-defined patterns on edge devices utilizing a hybrid cloud-chip approach. The embodiments of the disclosure may be utilized for customizing pattern recognition on an edge device through a smartphone or other general-purpose computer system. According to one embodiment, there may be a system for configuring user-defined recognition patterns at an edge device. The system may include a pattern recognition integrated circuit in the edge device. The pattern recognition integrated circuit may implement a machine learning pattern recognizer that generates an event recognition output in response to an input thereto based upon pre-trained machine learning weights stored in a memory of the pattern recognition integrated circuit. The system may also include a remote pattern recognition training service in communication with a secondary user device receptive to a training input of the user-defined recognition patterns. The remote pattern recognition training service may return a set of training weights corresponding to the training input. The system may further include an application interface that connects the pattern recognition integrated circuit to the secondary user device. The set of training weights returned to the secondary user device from the remote pattern recognition training service may be transferable to the machine learning pattern recognizer for storage in the memory of the pattern recognition integrated circuit through the application interface.

Another embodiment of the present disclosure may be a method for configuring user-defined recognition patterns at edge devices. The method may include capturing a training input on a secondary user device. There may also be a step of transmitting the training input to a remote pattern recognition training service, as well as a step of receiving a set of training weights corresponding to the training input and generated by the remote pattern recognition training service. The method may also include transmitting the set of training weights to a machine learning pattern recognizer executing on a pattern recognition integrated circuit on the edge device.

Another embodiment is directed to a non-transitory computer readable medium that includes instructions executable by a data processing device to perform the method for configuring user-defined recognition patterns at edge devices. The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of one exemplary edge device in which various embodiments of the system for recognizing user-defined patterns at edge devices may be implemented;

FIG. 2 is a block diagram of the system for recognizing user-defined patterns at edge devices utilizing a hybrid remote-local processing approach;

FIG. 3 is a flow diagram illustrating the steps of recognizing user-defined patterns at edge devices utilizing a hybrid remote-local processing approach;

FIG. 4 is a block diagram of one potential use case for the system for recognizing user-defined patterns in a remote control device;

FIG. 5 is a block diagram of another potential use case for the system for recognizing user-defined patterns in a headset;

FIG. 6 is a block diagram of one potential use case for the system for recognizing user-defined patterns in a refrigerator;

FIG. 7 is a block diagram of still another potential use case for the system for recognizing user-defined patterns in a smart watch;

FIG. 8 is a block diagram of another potential use case for the system for recognizing user-defined patterns in a smart television set;

FIG. 9 is a block diagram of a potential use case for the system for recognizing user-defined patterns in a home security system;

FIG. 10 is a block diagram of another potential use case for the system for recognizing user-defined patterns in a smart car remote; and

FIG. 11 is a block diagram of a potential use case for the system for recognizing user-defined patterns in a gesture controller.

### DETAILED DESCRIPTION

The detailed description set forth below in connection with the appended drawings is intended as a description of the several presently contemplated embodiments of a pattern recognition system with user-definable patterns on edge devices utilizing a hybrid remote and local processing approach. It is not intended to represent the only form in which such embodiments may be developed or utilized, and the description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

With reference to the block diagram of FIG. 1, one component of a pattern recognition system generally includes an edge device 10. As will be described in the context of the various use cases below, the edge device 10 may be a smart speaker, a smart television set, a headset, a television remote controller, a refrigerator, a smart watch, a smart home security system, a car remote, a gesture controller, or any other device that is capable of receiving an input and initiating further action on the device on which the input was received or any other device linked thereto. It is understood that conventional household appliances such as washing machines, dryers, dishwashers, ovens, garage door openers and the like may incorporate additional data processing capabilities and may thus be referred to as edge devices as well. These data processing capabilities may be utilized to implement a virtual assistant with which users may interact via voice commands, though it is also possible to interact via other inputs such as gestures and other image-based modalities. Within the audio context, the edge device 10 may respond to other types of audio besides user voice commands as will be elaborated upon below.

The edge device includes a main processor 12 that executes pre-programmed software instructions that correspond to various functional features of the edge device 10. These software instructions, as well as other data that may be referenced or otherwise utilized during the execution of such software instructions, may be stored in a memory 14. As referenced herein, the memory 14 is understood to encompass random access memory as well as more permanent forms of memory.

To the extent that the edge device 10 is a smart speaker, it is understood to incorporate a loudspeaker/audio output transducer 16 that outputs sound from corresponding electrical signals applied thereto. Furthermore, in order to accept audio input, the edge device 10 includes a microphone/audio input transducer 18. The microphone 18 is understood to capture sound waves and transduces the same to an electrical signal. According to various embodiments of the present disclosure, the edge device 10 may have a single microphone. However, it will be recognized by those having ordinary skill in the art that there may be alternative configurations in which the edge device 10 includes two or more microphones.

Both the loudspeaker 16 and the microphone 18 may be connected to an audio interface 20, which is understood to include at least an analog-to-digital converter (ADC) and a digital-to-analog converter (DAC). The ADC is used to convert the electrical signal transduced from the input audio waves to discrete-time sampling values corresponding to instantaneous voltages of the electrical signal. This digital data stream may be processed by the main processor, or a dedicated digital audio processor. The DAC, on the other hand, converts the digital stream corresponding to the output audio to an analog electrical signal, which in turn is applied to the loudspeaker 16 to be transduced to sound waves. There may be additional amplifiers and other electrical circuits that within the audio interface 20, but for the sake of brevity, the details thereof are omitted. Furthermore, although the example edge device 10 shows a unitary audio interface 20, the grouping of the ADC and the DAC and other electrical circuits is by way of example and convenience only, and not of limitation.

In between the audio interface 20 and the main processor 12, there may be a general input/output interface 22 that manages the lower-level functionality audio interface 20 without burdening the main processor 12 with such details. Although there may be some variations in the way the audio data streams to and from the audio interface 20 are handled thereby, the input/output interface 22 abstracts any such variations. Depending on the implementation of the main processor 12, there may or may not be an intermediary input/output interface 22.

According to some embodiments, the edge device 10 may also incorporate visual input and output peripheral components. Specifically, there may be a display 24 that outputs graphics corresponding to electrical signals the data representative thereof. The display 24 may be a matrix of light emitting elements arranged in rows and columns, with the elements thereof varying in size and technologies, such as liquid crystal displays (LCD), light-emitting diode (LED) displays and so on. It will also be appreciated that the display 24 may include simpler output devices such as segment displays as well as individual LED indicators and the like. The specific type of display 24 that is incorporated into the edge device 10 is driven by the information presentation needs thereof.

The display 24 receives the electrical signals to activate the display elements from a visual interface 26. In some implementations, the visual interface 26 is a graphics card that has a separate graphics processor and memory to offload the graphics processing tasks from the main processor 12. Like the audio interface 20 discussed above, the visual interface 26 may be connected to the general input/output interface 22 to abstract out the functional details of operating the display 24 and the visual interface 26.

The edge device 10 may further include an imager 28 that captures light from the environment and converts the same to electrical signals representative of the scene. A continuous stream or sequence of images may be captured by the imager 28, or a single image may be captured of a time instant in response to the triggering of a shutter. A variety of sensor technologies are known in the art, as are lenses, apertures, shutters, and other optical components that focus the light onto the sensor element for capture. Accordingly, such details of the imager 28 are omitted. The image data output by the imager 28 may be passed to the visual interface 26, and the commands to activate the capture function may be issued through the same. However, this is by way of example only, and some edge devices 10 may utilize a dedicated imager interface separate from that which controls the display 24. The imager 28 and the display 24 are shown connected to a unitary visual interface 26 only for the sake of convenience as representing functional corollaries of the other (e.g., image input vs. image output).

In addition to the foregoing peripheral devices, the edge device 10 may also include more basic input devices 30 such as buttons, keys, and switches with which the user may interact to command the edge device 10. These components may be connected directly to the general input/output interface 22.

The edge device 10 may also include a network interface 32, which serves as a connection point to a data communications network. This data communications network may be a local area network, the Internet, or any other network that enables a communications link between the edge device 10 and a remote note. In this regard, the network interface 32 is understood to encompass the physical, data link, and other network interconnect layers.

In order to communicate with more proximal devices within the same general physical space as the edge device 10, there may be a local communication interface 34. According to various embodiments, the local communication interface 34 may be a wireless modality such as infrared, Bluetooth, Bluetooth Low Energy, RFID, and so on. Alternatively, or additionally, the local communication interface 34 may be a wired modality such as Universal Serial Bus (USB) connections, including different standard generations and physical interconnects thereof (e.g., USB-A, micro-USB, mini-USB, USB-C, etc.). The local communication interface 34 is likewise understood to encompass the physical, data link, and other network interconnect layers, but the details thereof are known in the art and therefore omitted from the present disclosure. In various embodiments, a Bluetooth connection may be established between a smartphone and the edge device 10 to implement certain features of the present disclosure.

As the edge device 10 is electronic, electrical power must be provided thereto in order to enable the entire range of its functionality. In this regard, the edge device 10 includes a power module 36, which is understood to encompass the physical interfaces to line power, an onboard battery, charging circuits for the battery, AC/DC converters, regulator circuits, and the like. Those having ordinary skill in the art will recognize that implementations of the power module 36 may span a wide range of configurations, and the details thereof will be omitted for the sake of brevity.

The main processor 12 is understood to control, receive inputs from, and/or generate outputs to the various peripheral devices as described above. The grouping and segregation of the peripheral interfaces to the main processor 12 are presented by way of example only, as one or more of these components may be integrated into a unitary integrated circuit. Furthermore, there may be other dedicated data processing elements that are optimized for machine learning/artificial intelligence applications. One such integrated circuit is the AONDevices high-performance, ultra-low power edge AI device, AON1100 pattern recognition chip/integrated circuit. However, it will be appreciated by those having ordinary skill in the art that the embodiments of the present disclosure may be implemented with any other data processing device or integrated circuit utilized in the edge device 10. Although a basic enumeration of peripheral devices such as the loudspeaker 16, the microphone 18, the display 24, the imager 28, and the input devices 30 has been presented above, the edge device 10 need not be limited thereto. In some cases, one or more of these exemplary peripheral devices may not be present, while in other cases, there may be other, additional peripheral devices.

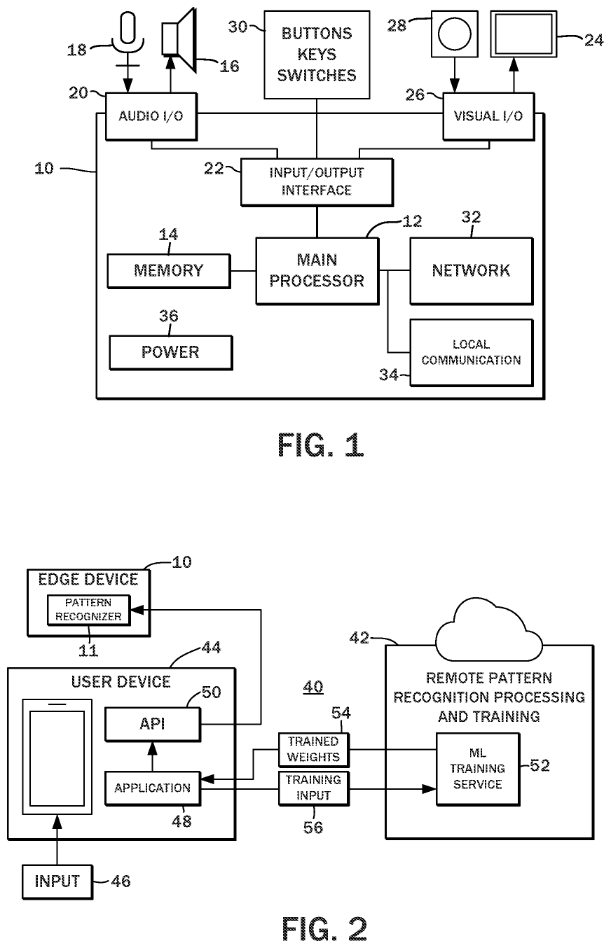

Referring now to the block diagram of FIG. 2, the above-described edge device 10 is contemplated to be part of a pattern recognition system 40 with user-definable patterns on edge devices utilizing a hybrid remote and local processing approach. Again, the edge device 10 may be an interface to an underlying apparatus, appliance, machine, or the like that can be controlled with natural human inputs such as voice commands, physical gestures, and so on. In typical implementations, the more complex natural input processing is handled by a remote service 42, while the edge device 10 may be limited to wake functions based on a few pre-programmed input patterns, capturing the subsequent user input for transmission to the remote service 42, and executing upon the recognized commands. As the natural input can span a variety of modalities, the processing thereof will be referred to more generally as pattern recognition.

As indicated above, the main processor 12 may be specially configured for machine learning/pattern recognition functions and be programmed to function with pre-trained weights that are stored in the memory 14. Accordingly, the main processor 12 may also be referred to as a pattern recognition integrated circuit. The specific machine learning modality that is implemented may be varied, including multilayer perceptrons, convolutional neural networks (CNNs), recurrent neural networks (RNNs) and so on that utilize such pre-trained weights to perform pattern recognition functions associated therewith. These may be referred to more generally as a machine learning pattern recognizer 11. According to various embodiments of the present disclosure, the pre-trained weights can be re-programmed in cooperation with the remote service 42.

In addition to the remote service 42 and the edge device 10, the system 40 also includes a user device 44. Conventionally, this is understood to be a smartphone that incorporates various communications modalities and one or more input and output modalities such as touch screen displays, microphones, speakers, cameras, and so on. Furthermore, the user device 44 is understood to incorporate a general-purpose data processor that can execute pre-programmed software instructions and generate outputs on, for example, the display, based on inputs 46 thereto. Among the software instructions that such processor can execute is an application 48 that serves as the interface to the edge device 10 as well as to the remote service 42. When the application 48 communicates with the edge device 10, it may do so via an application programming interface (API) 50. The API 50 may utilize the local communications capabilities of the user device 44 to establish a link to the edge device 10 and specifically the local communication interface 34 thereof. In this regard, the user device 44 may include a Bluetooth, USB, or other wireless or wired local data communications modality that corresponds to that which is implemented on the local communication interface 34 of the edge device 10. The user device 44 need not be limited to a smartphone, however, and any other general-purpose computer such as desktop/laptop computers, tablets, and the like on which the application 48 may run can be substituted without departing from the scope of the present disclosure.

The remote service 42 further includes a machine learning training service 52 that is comprised of a set of training tools that generates trained weights 54 from the training input 56 provided by the user device 44. Because of the increased processing capabilities of a remote or cloud-based system, the training service 52 is capable of rapidly training the machine learning system using the provided data and generate a set of weights that may be utilized in the pattern recognizer 11 of the edge device 10. In further detail, the present disclosure contemplates a setup or re-training procedure for training the edge device 10 to recognize an alternative, user-defined pattern that may be initiated through the user device 44. Through the application 48, this configuration process prompts the user to provide an alternative sample input 46 on which to train the pattern recognizer 11. The sample input 46 may be an audio of the user's spoken name, an audio of pet sounds such as a dog barking, an audio made by an object such as glass breaking, or any other audio sample. The sample input 46 may also be an image of a person within the household, hand gestures associated with inputs/commands to a game, and so on. Depending on the kind of sample input 46 that is expected, the application 48 may apply various filters that are tuned or specific to that input type.

The application 48 establishes a communications session with the remote service 42, uploading the training input 56 to the machine learning training service 52. Based on the training input 56, the training service 52 generates the set of trained weights 54 and is transferred to the application 48. The user device 44, via the API 50, uploads the trained weights 54 to the pattern recognizer 11, such that it is tuned to better recognize subsequent inputs or commands directly to the edge device 10 as corresponding to a known recognition pattern that is correlated to the trained weights 54.

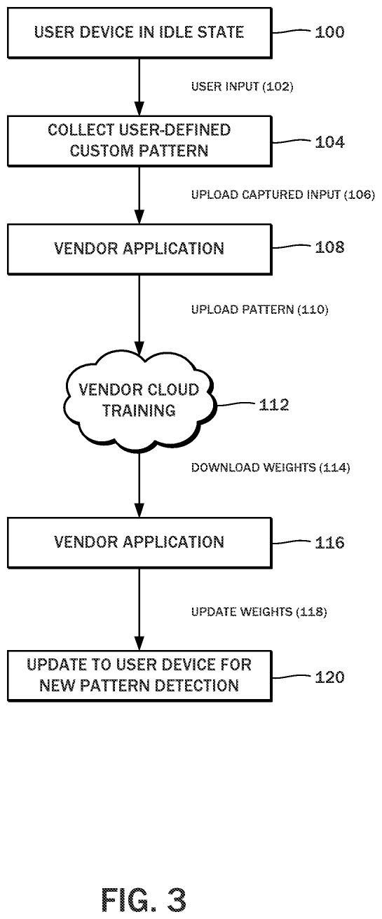

With reference to the flow diagram of FIG. 3, additional details of the foregoing hybrid edge device-cloud training process will be described. In a first state 100, the user device 44 is in an idle state. The user may invoke the application 48 to begin the training procedure which may involve a sequence of guided steps to select certain training options, designate the action for which the training input is to be correlated, and so on. In response to the prompts provided through the training procedure, the user may provide an input according to a step 102. The is understood to correspond to the input 46 described above. In a step 104, the user-defined custom pattern is collected by the user device 44. A variety of pre-processing steps may take place, including filtering and segmenting for only the desired portion of the input 46 to yield the training input 56. This is provided/uploaded to the application 48 in accordance with a step 106. At state 108, the application 48, which may be referred to as a vendor application because it is preferably provided to the user device 44 by the vendor of the edge device 10, has the training input 56. The application 48 then uploads the training input 56 to the remote service 42 according to a step 110.

In a state 112, the machine learning training service 52 processes the uploaded training input 56 and generates a set of trained weights 54, which are then downloaded or returned to the user device 44 in a step 114. In a state 116, the application 48 has the trained weights 54. The application 48, utilizing the local communication facilities of the user device 44, establishes a short-range data link to the edge device 10, then using that data link, uploads the trained weights 54 in a step 118. In a state 120, the edge device 10 is updated with the new trained weights 54 corresponding to the input 46 that was provided to the user device 44. Accordingly, the pattern recognizer 11 can utilize the updated trained weights 54 so that the edge device 10 can take further action in response to an input to the edge device 10 that is recognized as corresponding the training input 56. Until or unless the input to the edge device 10 is recognized as a pattern that has been re-programmed according to the foregoing, the edge device 10 returns to an idle state. The edge device 10 may act independently of the user device 44, or work in conjunction with the same, such that a notification of detecting the trained pattern may be generated on the user device 44.

The system 40 may be adopted in numerous use cases such as customizing a television remote controller, a headset, and smart home devices. For example, the sound of the user's child crying, the sound of the user's home doorbell ringing, or a custom ringtone may be trained on the remote controller such that the television volume may be lowered automatically. In the example of the headset, the user's name may be trained such that the headset will notify the user when an immersive listening session (e.g., music is being played loudly) is interrupted by someone calling the user's name. Custom voice commands may be added to home automation devices such as refrigerators, door locks, thermostats, smart televisions, and so on.

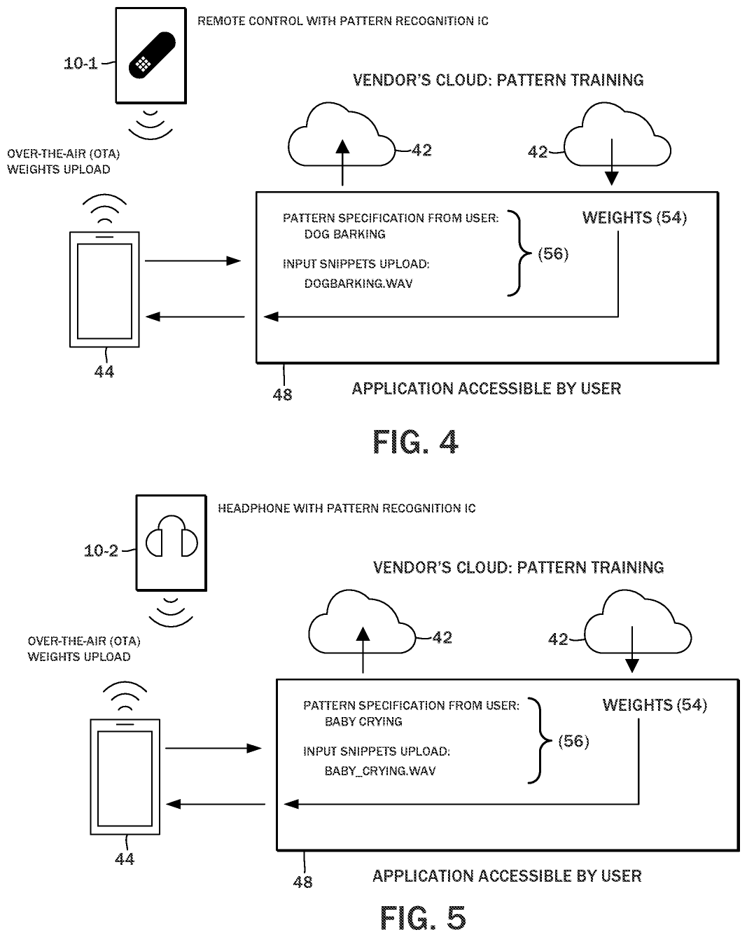

FIG. 4 illustrates one exemplary use case of a television remote controller/edge device 10-1, with the user device 44 uploading an input 56 comprising an audio snippet of a dog barking. Via the application 48, the upload of the audio snippet may be specified as barking dog. The audio snippet is uploaded to the remote service 42 for training, and the resultant trained weights 54 is returned to the application 48. The user device 44 then uploads the trained weights 54 to the remote controller 10-1 over a local communication link, which in the illustrated example is an over-the-air transfer over a short-range wireless modality such as Bluetooth. The trained weights 54 are stored on the pattern recognition integrated circuit embedded in the remote controller 10-1. When the microphone 18 on the remote controller 10-1 picks up an audio of the same barking dog, the pattern recognition system 40 thereof recognizes it as such and triggers an event notification. The event notification may, in turn, initiate a predetermined sequence of actions in relation to the television set controlled by the remote controller 10-1, such as decreasing the output volume of the television set, turning off the television set, etc.

FIG. 5 illustrates another exemplary use case of a headphone/edge device 10-2, with the user device 44 uploading an input 56 comprising an audio snippet of a baby crying. Via the application 48, the upload of the audio snippet may be specified as a baby crying. The audio snippet is uploaded to the remote service 42 for training, and the resultant trained weights 54 is returned to the application 48. The user device 44 then uploads the trained weights 54 to the headphone 10-2 over a local communication link, which in the illustrated example is an over-the-air transfer over a short-range wireless modality. The trained weights 54 are stored on the pattern recognition integrated circuit embedded in the headphone 10-2. When the microphone 18 on the headphone 10-2 picks up an audio of the baby crying, the pattern recognition system 40 thereof recognizes it as such and triggers an event notification. The event notification may, in turn, initiate a predetermined sequence of actions in relation to the headphone 10-2, such as decreasing the output volume or muting the output sound entirely.

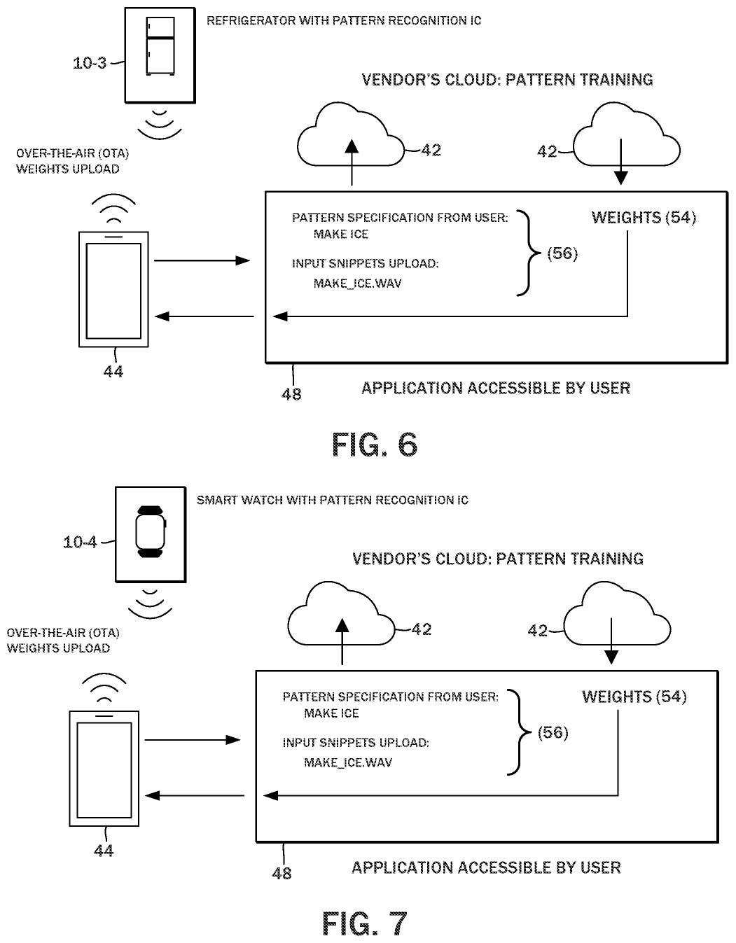

FIG. 6 is a block diagram showing yet another exemplary use case of the system 40, specifically in the context of a refrigerator/edge device 10-3. From the user device 44, an input 56 comprising an audio snippet of the user issuing a vocal command to “make ice” is uploaded. Via the application 48, the upload of the audio snippet may be specified as a command to make ice. The audio snippet is uploaded to the remote service 42 for training, and the resultant trained weights 54 is returned to the application 48. The user device 44 then uploads the trained weights 54 to the refrigerator 10-3 over a local communication link, which may be an over-the-air transfer over a short-range wireless modality. The trained weights 54 are stored on the pattern recognition integrated circuit embedded in the refrigerator 10-3. When the microphone 18 on the refrigerator 10-3 picks up an audio of the vocal command, the pattern recognition system 40 thereof recognizes it as such and triggers an event notification and commands the refrigerator 10-3 to begin the ice-making process.

The block diagram of FIG. 7 illustrates another exemplary use case of the system 40 for a smart watch/edge device 10-4. The smart watch may be trained for various commands such as “view schedule,” and so an input 46 comprising an audio snippet of the user issuing a vocal command to “view schedule” may be uploaded from the user device 44. Via the application 48, the upload of the audio snippet may be specified as a command to view the user's schedule as maintained in the calendaring system of the smart watch 10-4. The audio snippet is uploaded to the remote service 42 for training, and the resultant trained weights 54 is returned to the application 48. The user device 44 then uploads the trained weights 54 to the smart watch 10-4 over a local communication link, which may be an over-the-air transfer over a short-range wireless modality. The trained weights 54 are stored on the pattern recognition integrated circuit embedded in the smart watch 10-4. When the microphone 18 on the smart watch 10-4 captures n audio of the vocal command to “view schedule”, the pattern recognition system 40 thereof recognizes it as such and triggers an event notification and commands the smart watch 10-4 to display the user's calendar.

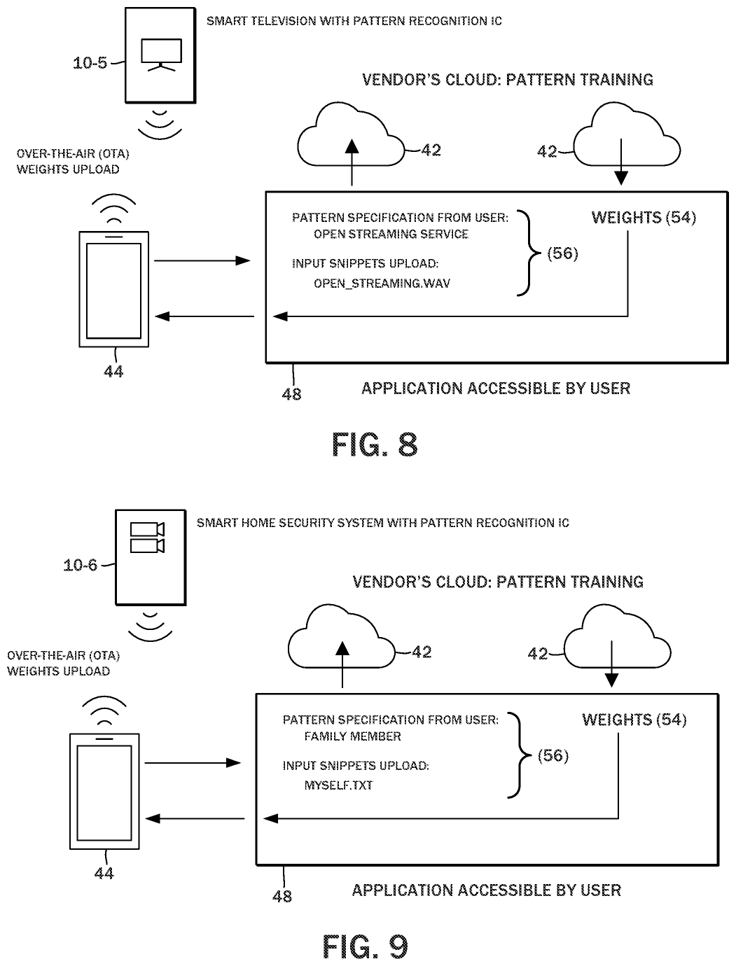

FIG. 8 illustrates another exemplary use case of a smart television/edge device 10-5, with the user device 44 uploading an input 56 comprising an audio snippet of the user issuing a command to open a streaming service, e.g., Netflix, Amazon Prime Video, Disney Plus, and the like. Via the application 48, the upload of the audio snippet may be specified as a command to open a streaming service. The audio snippet is uploaded to the remote service 42 for training, and the resultant trained weights 54 is returned to the application 48. The user device 44 then uploads the trained weights 54 to the smart television set 10-5 over a local communication link, which in the illustrated example is an over-the-air transfer over a short-range wireless modality. The trained weights 54 are stored on the pattern recognition integrated circuit embedded in the smart television 10-5. When the microphone 18 on the television 10-5 picks up an audio of the user issuing the command to open the streaming service, the pattern recognition system 40 thereof recognizes it as such and triggers an event notification. The event notification may, in turn, initiate the corresponding command to the smart television set 10-5 to open the streaming service.

FIG. 9 illustrates another use case of a smart home security system 10-6. The natural input 46 used in this situation, however, may be one or more images of the user as captured by an on-board camera of the user device 44. Video inputs may also be captured by the edge device. For example, the images may be correlated with a designation that the person so recorded is a member of the household, and so an intruder alarm need not be triggered. Additional functionality may be triggerable based upon an identified match between a person captured by the security system and the trained image(s) or video(s). Again, with the application 48, the image(s) or video(s) may be uploaded to the remote service 42 for training, and the resultant trained weights 54 is returned to the application 48. The user device 44 then uploads the trained weights 54 to the smart security system 10-6 over a local communication link. The trained weights 54 are stored on the pattern recognition integrated circuit embedded in the security system 10-6.

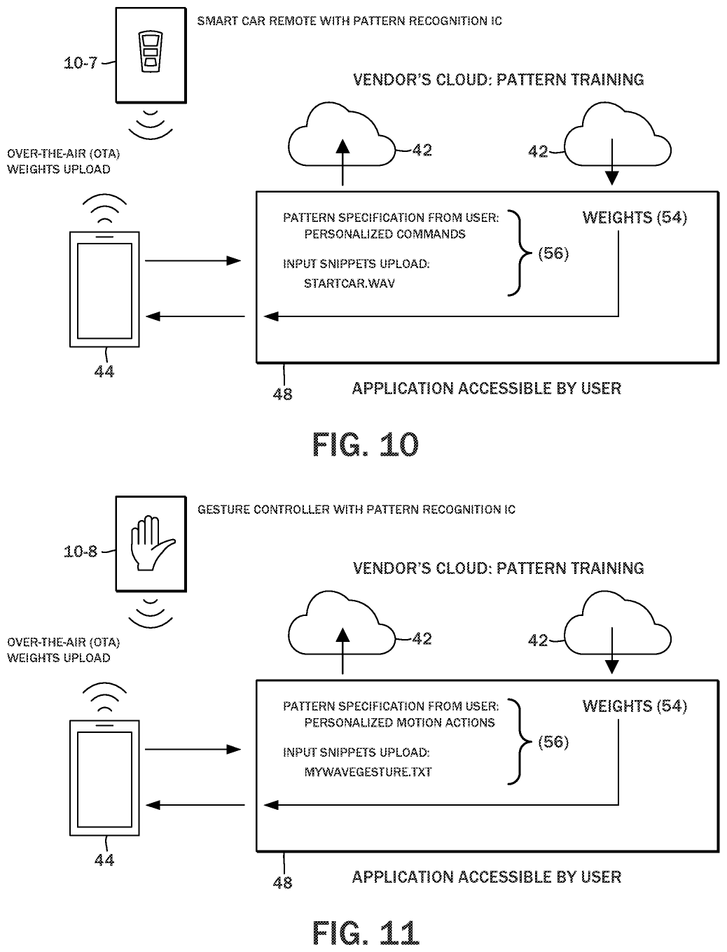

FIG. 10 is a block diagram of exemplary use case of the system 40 adapted for a smart car remote/edge device 10-7, which may include an microphone to accept vocal commands from the driver. Again, from the user device 44, an input 56 comprising an audio snippet of the user issuing a vocal command to “start car” or any other activatable feature of the vehicle such as opening doors, opening trunks, and the like is uploaded. Via the application 48, the upload of the audio snippet may be specified as the corresponding personalized command. The audio snippet is uploaded to the remote service 42 for training, and the resultant trained weights 54 is returned to the application 48. The user device 44 then uploads the trained weights 54 to the smart car remote 10-7 over a local communication link. The trained weights 54 are stored on the pattern recognition integrated circuit embedded in the smart car remote 10-7. When the microphone 18 on the smart car remote 10-7 captures an audio of the vocal command, the pattern recognition system 40 thereof recognizes it as such and triggers an event notification and commands the smart car remote 10-7, and ultimate the vehicle to which it is paired, to execute the command.

FIG. 11 illustrates another use case of the system 40 in the context of a gesture controller 10-8. The natural input 46 used in this situation may be one or more images of hand gestures provided by the user as captured by an on-board camera of the user device 44. Video inputs may also be captured. The images may be correlated with a specific commands that are to be executed in response to the input, which may be referred to generally as personalized motion actions. The image(s) or video(s) may be uploaded to the remote service 42 for training with the application 48, and the resultant trained weights 54 is returned to the same. The user device 44 then uploads the trained weights 54 to the gesture controller 10-8 over a local communication link. The trained weights 54 are stored on the pattern recognition integrated circuit embedded in the gesture controller 10-8. When the gesture controller 10-8 captures an image corresponding to the specified command of the trained weight/training input, it may trigger an event notification that results in further actions being taken.

The particulars shown herein are by way of example and for purposes of illustrative discussion of the embodiments of a pattern recognition system with user-definable patterns on edge devices utilizing a hybrid remote and local processing approach, and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A system for configuring user-defined recognition patterns at an edge device, the system comprising:
a pattern recognition integrated circuit in the edge device, the pattern recognition integrated circuit implementing a machine learning pattern recognizer that generates an event recognition output in response to an input thereto based upon pre-trained machine learning weights stored in a memory of the pattern recognition integrated circuit;
a remote pattern recognition training service in communication with a secondary user device receptive to a training input of the user-defined recognition patterns, the remote pattern recognition training service returning a set of training weights corresponding to the training input; and
an application interface connecting the pattern recognition integrated circuit to the secondary user device, the set of training weights returned to the secondary user device from the remote pattern recognition training service being transferable to the machine learning pattern recognizer for storage in the memory of the pattern recognition integrated circuit through the application interface.

2. The system of claim 1, wherein the machine learning pattern recognizer is selected from a group consisting of: a multilayer perceptron (MCP), a convolutional neural network (CNN), and a recurrent neural network (RNN).

3. The system of claim 1, wherein the training input is accompanied by an input type definition.

4. The system of claim 3, wherein the input type definition is selected through an application executing on the secondary user device and capturing the training input.

5. The system of claim 1, wherein the machine learning pattern recognizer generates the event recognition output based upon an identification of an arbitrary user input to the edge device as matching a recognition pattern correlated to the set of training weights transferred from the secondary user device.

6. The system of claim 1, wherein the input is audio.

7. The system of claim 1, wherein the input is one or more images.

8. A method for configuring user-defined recognition patterns at edge devices, the method comprising:
capturing a training input on a secondary user device;
transmitting the training input to a remote pattern recognition training service;
receiving a set of training weights corresponding to the training input and generated by the remote pattern recognition training service; and
transmitting the set of training weights to a machine learning pattern recognizer executing on a pattern recognition integrated circuit on the edge device.

9. The method of claim 8, wherein the machine learning pattern recognizer is selected from a group consisting of: a multilayer perceptron (MCP), a convolutional neural network (CNN), and a recurrent neural network (RNN).

10. The method of claim 8, further comprising:
receiving a selection of an input type definition on the secondary user device contemporaneously with the capturing the training input.

11. The method of claim 10, wherein the input type definition is associated with the training input, and with the set of training weights generated from the training input.

12. The method of claim 8, further comprising:
receiving, on the edge device, an arbitrary user input; and
generating an event recognition output based upon a matching identification of the arbitrary user input to a recognition pattern correlated to the set of training weights transferred from the secondary user device.

13. The method of claim 8, wherein the training input is audio.

14. The method of claim 8, wherein the training input is one or more images.

15. An article of manufacture comprising a non-transitory program storage medium readable by a computing device, the medium tangibly embodying one or more programs of instructions executable by the computing device to perform a method for configuring user-defined recognition patterns at edge devices, the method comprising:
capturing a training input on a secondary user device;
transmitting the training input to a remote pattern recognition training service;
receiving a set of training weights corresponding to the training input and generated by the remote pattern recognition training service; and
transmitting the set of training weights to a machine learning pattern recognizer executing on a pattern recognition integrated circuit on the edge device.

16. The article of manufacture of claim 15, wherein the machine learning pattern recognizer is selected from a group consisting of: a multilayer perceptron (MCP), a convolutional neural network (CNN), and a recurrent neural network (RNN).

17. The article of manufacture of claim 15, wherein the method further includes receiving a selection of an input type definition on the secondary user device contemporaneously with the capturing the training input.

18. The article of manufacture of claim 15, wherein the input type definition is associated with the training input, and with the set of training weights generated from the training input.

19. The article of manufacture of claim 15, wherein the input is audio.

20. The article of manufacture of claim 15, wherein the input is one or more images.
